(19) United States
(12) Patent Application Publication
(10) Pub. No.: US 2008/0252679 A1
(43) Pub. Date: Oct. 16, 2008

(54) Ink Jet Device for the Controlled Positioning of Droplets of a Substance Onto a Substrate, Method for the Controlled Positioning of Droplets of a Substrate, and Use of an Ink Jet Device

(75) Inventors: Anke Pierik, Eindhoven (NL); Johan Frederik Dijksman, Eindhoven (NL); Dirkjan Bernhard Van Dam, Eindhoven (NL); Antonius Johannes Jo Wismans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,938

(22) PCT Filed: Oct. 3, 2006
(86) PCT No.: PCT/IB2006/053611

§ 371 Date: Apr. 2, 2008

(30) Foreign Application Priority Data
Oct. 7, 2005 (EP) 05109343.3

(51) Int. Cl. B41J 2/165

(52) U.S. Cl. 347/19

(57) ABSTRACT

The invention provides an ink jet device for the controlled positioning of droplets of a substance onto a substrate, the device comprising at least a print head with a nozzle designed to eject the droplet, the device further comprising at least one acoustic sensor arranged for detecting the landing of the droplet on the substrate. A feedback loop stops the printing process the moment the landing of a droplet is not detected within a predetermined delay time.

The present invention relates to an ink jet device for a controlled positioning of droplets of a substance onto a substrate. The present invention further relates to a method for the controlled positioning of droplets of a substance onto a substrate using an ink jet device. The present invention further relates to the use of an ink jet device.

The present invention discloses an ink jet device for the controlled positioning of droplets of a substance onto a substrate, a method, and the use of an ink jet device. Especially for medical diagnostics, substrates are needed where specific substances are positioned in a very precise and accurate manner. These substances are usually to be positioned on a substrate in order to perform a multitude of biochemical tests or reactions on the substrate. The ink jet device, the method for the controlled positioning of droplets of a substance, and the use of an ink jet device according to the present invention are preferably applied to the printing process of substances onto a substrate, which printing process has to be extremely reliable in whether a droplet of the substance has actually been released onto the substrate and in whether a droplet of the substance has been correctly positioned on the substrate.

Ink jet devices are generally known. For example, US Patent application US 2004/0196319 A1 discloses an image recording apparatus including a recording head having a plurality of nozzles, a carriage, a transfer mechanism, a driving mechanism, a detection mechanism which optically detects an injection date, and a controller. The plurality of nozzles are divided into a plurality of nozzle groups. The controller makes an injection timing for each of the nozzle groups different from that of any other nozzle group. The recording head or the plurality of recording heads according to the cited US patent application can be positioned outside a printing area such that a control operation can be performed. The control operation can provide an answer to the question whether one or a plurality of printing heads or printing nozzles do not work correctly, for example because ink is clogging the nozzle or the like. When the printing head is positioned outside the printing area in the control or detection area, the printing heads or printing nozzles do not face the recording medium onto which the print heads apply ink droplets in the printing area. In the detection area, the trajectory of droplets intersect a light beam detected by a photodetector, leading to a control of the proper working of the printing head. One drawback of the known device is that it is not reliably possible to answer the question whether an individual droplet has actually been deposited onto the substrate or onto the printing medium because a control operation is only performed from time to time. This strongly limits the reliability of the printing or ink jet device, especially for applications where an accurate and reliable printing process is essential.

It is therefore an object of the present invention to provide an ink jet device for the controlled positioning of droplets of a substance onto a substrate that has a higher degree of reliability of the positioning of a droplet onto the substrate.

The above object is achieved by an ink jet device and a method for the controlled positioning of droplets according to the present invention and by the use of an ink jet device according to the present invention. The ink jet device for the controlled positioning of the droplets of a substance onto a substrate comprises at least a print head comprising a nozzle designed to eject a droplet, the ink jet device further comprising at least one acoustic sensor arranged such that the landing of the droplet on the substrate is detected by the acoustic sensor.

An advantage of the ink jet device according to the invention is that it is possible to detect the landing of droplets by using the at least one acoustic sensor and therefore to have a reliable feedback as to whether an ejected droplet has actually landed on the substrate or not.

In a preferred embodiment of the present invention, the vibrations of the substrate during landing of the droplet are detected. This makes it possible to detect the landing of the droplet in a very simple yet efficient and reliable way. This means that the detection of a droplet can be made highly unequivocal and undisturbed to a high degree by any sources of error.

Very preferably, the print head is provided on a first side of the substrate, and the at least one acoustic sensor is provided on a second side of the substrate opposite to the first side. This has the advantage that no space on the first side of the substrate need be used for the acoustic sensor. This is especially important because space around the print head is at a premium. The closer the print head is positioned to the substrate, the more accurate the landing of the droplet. Furthermore, a better distinction between droplets landing at different locations on the substrate is made possible by the acoustic sensor being mounted on the second side of the substrate.

The acoustic sensor is preferably a microphone. This is a very cost-effective way of providing an acoustic sensor according to the invention.

In a preferred embodiment of the present invention, the ink jet device comprises a plurality of acoustic sensors. This has the advantage that a better distinction between the location of a droplet hitting the substrate and a droplet landing on the substrate is possible.

It is further preferred that the substrate comprises a plurality of substrate areas, each substrate area preferably being a separate membrane held by a membrane holder. A plurality of separate membranes can thus be produced with the use of the inventive ink jet device.

Very preferably, at least one acoustic sensor is assigned to each substrate area. This has the advantage that a still better distinction between the locations of a droplet hitting the substrate and a droplet landing on the substrate is possible.

Furthermore, it is preferred that the sensor signal of the at least one acoustic sensor assigned to one of the plurality of substrate areas strongly differs for a droplet landing on the one of the substrate areas as opposed to a droplet landing on a different one of the substrate areas. This even renders it possible to discriminate between the landing of one droplet on one substrate area and that of another droplet on a neighboring substrate area if these landings are simultaneous or only very closely spaced in time.

It is further preferred that the ink jet device comprises a print table or a fixture plate, wherein the print table or the fixture plate comprises a recess or a hole for each membrane holder, and/or that the acoustic sensor assigned to each substrate area is provided in the recess or hole. A relatively precise separation of droplets landing on different membrane areas is made possible thereby.

It is much preferred according to the present invention to use an ink jet device which further comprises a (preferably stable and heavy) print table and a printing bridge, a fixture plate mounted rigidly to a linear stage allowing a linear motion in a first direction (X-direction) relative to the print table, the print head being attached to a print head holder which is mounted on a linear stage allowing a linear motion relative to the printing bridge in a second direction (Y-direction). It is thus possible to print or release droplets of a substance onto a large area of application. The production of printed products can thus be made quite cost-effective because large substrates or individual membranes can be printed as one batch.

According to the present invention, it is preferred that the substrate is a flat substrate, a structured substrator a porous substrate. More preferably, the substrate is a nylon membrane, nitrocellulose membrane, or PVDF membrane. Since the substrate is preferably porous, the spots or the droplets do not only lie on the surface, but also penetrate into the membrane.

Further preferably, the substrate comprises a plurality of substrate locations, the substrate locations being separated from each other by at least the average diameter of a droplet positioned in one of the substrate locations. This makes it possible to locate different droplets of a substance precisely and independently in exact respective locations on the substrate. It is also possible and advantageous to apply a plurality of droplets on the same substrate location.

According to the present invention, it is very much preferred that the substance is transparent or highly translucent. Very preferably, the substance is an aqueous solution wherein different molecules or different compounds, especially bio-molecules, are present.

The present invention also includes a method for the controlled positioning of droplets of a substance onto a substrate using an ink jet device that comprises at least a print head having a nozzle designed to eject a droplet, the ink jet device further comprising at least one acoustic sensor arranged such that the landing of the droplet on the substrate is detected by the acoustic sensor. A very high degree of reliability in the printing process can be achieved thereby.

It is preferred according to the present invention that a feedback loop stops the printing process if, after an ejection of a droplet, the landing of this droplet on the substrate is not detected by the acoustic sensor within a predetermined delay time. This has the advantage that the printing process is stopped when something goes wrong during printing (the feedback loop immediately interferes with the printing process) and that the substrate being printed is marked by the software controlling the entire printing operation as “incorrect”, so that it will not be handled further as if it were a correct product. In many cases, it cannot be easily determined afterwards whether a droplet has indeed landed on the substrate, especially if the droplet is absorbed by the substrate and the droplet provided comprises a transparent evaporating substance. Furthermore, software serves to ensure that each landing of a droplet on the substrate is registered. In a preferred embodiment, this analysis is followed by a feedback loop which stops the printer if the analysis of the ejected droplet shows that something has gone wrong during printing.

Very preferably, the acoustic sensor records data on? a sensor signal after a droplet has been ejected from the nozzle. If during a predefined delay time after the ejection of the droplet the acoustic sensor has not recorded a signal that can be allocated to the landing of the droplet on the substrate, an error in the printing process is detected. This has the advantage over the prior art that each droplet is traceable.

It is further preferred that in a first step the position of the print head relative to the substrate is calibrated and in a second step the substance is positioned on the membrane. These method steps advantageously render it possible to locate the droplets of the substance on the substrate or on the membrane very reliably.

In a still further preferred embodiment, a plurality of different substances are applied to the substrate such that a first substance is positioned in a first substrate location and the second substrate is positioned in a second substrate location. This has the advantage that a multitude of different substances can be provided on the substrate, which may be used in a biochemical assay cartridge, with one and the same printing process by merely exchanging a print head or a substance reservoir for printing.

The present invention also includes the use of an ink jet device according to the present invention, wherein the substance comprises a biochemical reactant and/or a nucleic acid and/or a polypeptide and/or a protein. The use of the inventive ink jet device for such a purpose renders it possible to position a certain number of substances on a substrate very accurately.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference numerals mentioned below refer to the attached drawings.

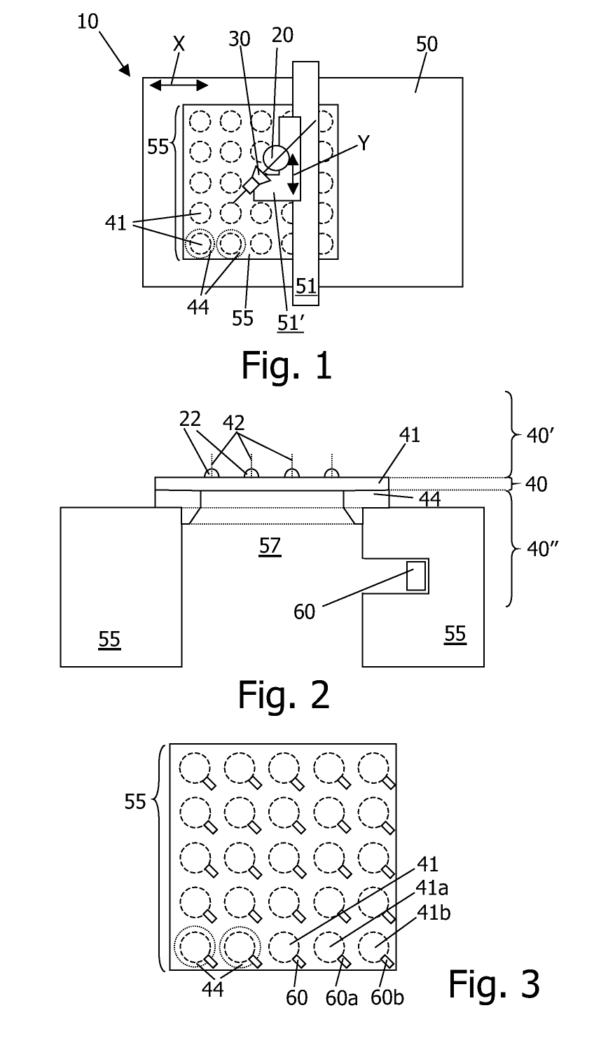

FIG. 1 is a diagrammatic plan view of an embodiment of the ink jet device of the present invention,

FIG. 2 is a diagrammatic cross-section through a substrate area, a membrane holder and a fixture plate,

FIG. 3 illustrates schematically a fixture plate of an inventive ink jet device with a plurality of membrane areas and acoustic sensors,

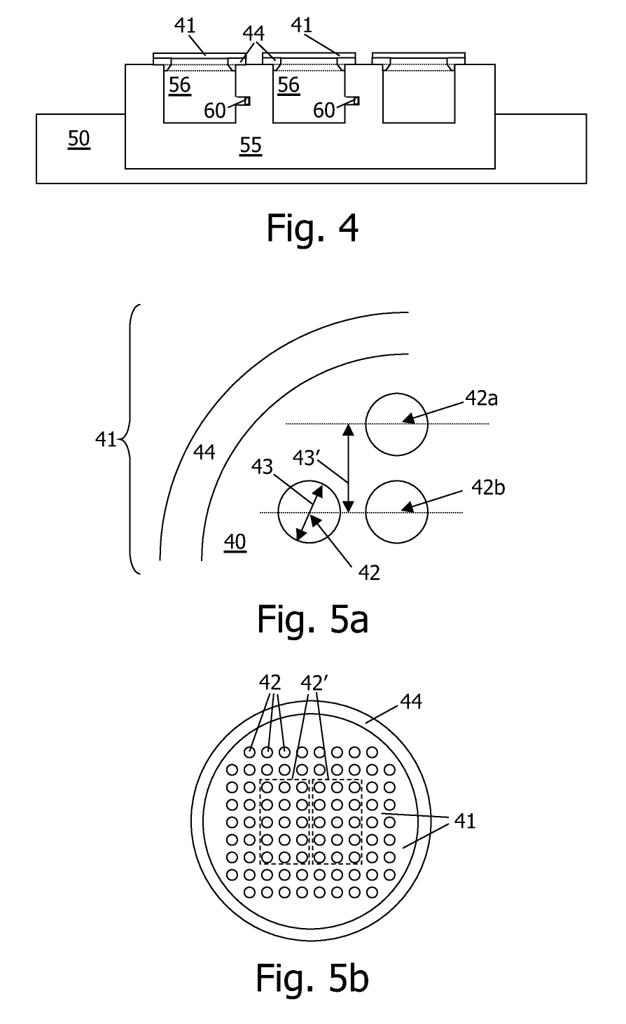

FIG. 4 illustrates schematically an alternative embodiment of a fixture plate of an inventive ink jet device.

FIGS. 5a and 5b illustrate schematically part of a substrate area together with a membrane holder and a complete membrane,

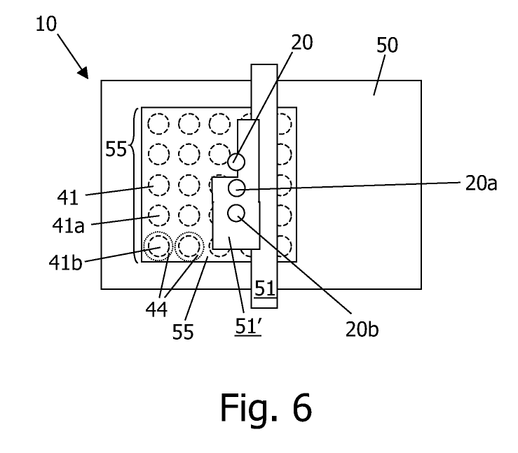

FIG. 6 illustrates schematically an embodiment of an ink jet device comprising a plurality of print heads.

The present invention will be described with respect to particular embodiments and with reference to certain drawings. The invention, however, is not limited thereby but only by the claims. The drawings described are only schematic and are non-limiting. In the drawings, the size of some of the elements may be exaggerated and not drawn to scale for illustrative purposes.

Where an indefinite or definite article is used in referring to a singular noun, e.g. “a”, “an”, “the”, this also covers a plural of that noun unless specifically stated otherwise.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in sequences other than those described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in orientations other than those described or illustrated herein.

It is to be noticed that the term “comprising” used in the present description and claims should not be interpreted as being restricted to the means listed thereafter; it does not exclude other elements or steps. Thus, the scope of the expression “a device comprising means A and B” should not be limited to devices consisting only of components A and B. It means that, with respect to the present invention, the only relevant components of the device are A and B.

FIG. 1 is a schematic plan view of the ink jet device 10 according to the present invention. On a print table 50 (preferably made of heavy granite), a fixture plate 55 is fixedly attached to a linear stage that allows a linear motion with respect to the granite table. A number of membrane holders 44 with membranes 41 are positioned in this fixture plate 55. The membranes 41 together form the substrate 40. Therefore, the membranes 41 may also be called “substrate 41”. For the sake of clarity, in the following, the term “substrate 40” refers to the totality of the printable area of the “membranes 41”. The membrane holder 44 is basically only a ring 44. A round membrane 41 is welded to this ring. After printing, the ring 44 and the membrane 41 thus together form the final product. A printing bridge 51 is moveably provided relative to the fixture plate 55 and rigidly mounted relative to the print table 50. The printing bridge 51 carries the moveable print head holder 51′. The stage with the fixture plate 55 is moveable in a first direction, the X-direction. A print head 20 is mounted to the moveable print head holder 51′ such that it is moveable in a second direction, the Y-direction, relative to the printing bridge 51. According to the present invention, it is preferred that the first direction (X-direction) and the second direction (Y-direction) are mutually perpendicular. The print head 20 can be moved over a certain area of a fixture plate 55 as a result and can release droplets of a substance which is stored in a reservoir (not shown) near the print head 20. The membranes 41 are mounted in the fixture plate 55, also called registration plate 55, at uniform distances in the X-direction and uniform distances in the Y-direction. The distance in the X-direction may differ from the distance in the Y-direction. According to the present invention, a control camera 30 is provided such that a droplet (shown in FIG. 2) of a substance being ejected from a nozzle of the print head 20 can be detected by the control camera 30. In a preferred embodiment of the present invention shown in FIG. 1, the control camera 30 is fixedly positioned near the print head 20 on the movable print head holder 51′.

The substrate 40 may be made of a bioactive membrane used for the detection of infectious diseases. Medical diagnostics demand a very high reliability of the printing process. The read-out of the fluorescent pattern relates diseases directly to the positions of the specific capture probes. Therefore, it is absolutely necessary to have a very reliable process for the correct positioning of the capture probes on the substrate 40. Ink jet printing is a precision dosing technique without any feedback about the actual presence and placement of the droplets on the substrate 40. The problem is that there is no information on how the operation proceeds. The present invention describes an acoustical method of following the printing process instantaneously. Acoustic sensors, especially microphones, are mounted on the ink jet device 10, which sensors detect whether a droplet has landed on the substrate 40 or not. The system stops the printing process the very moment a droplet is missing and marks the membrane 41 or substrate area 41 just printed. The operator can now adjust the print head (pipette) such that it operates according to the specification again, and the printing process can be resumed. Later on, the marked membrane can be removed from the batch of printed membranes 41.

The print table 50 is preferably a granite table. Alternatively, a different, very heavy material may be used. According to the present invention, the print table 50 should be arranged in an environment which has very little vibrational disturbances. A precision linear stage is mounted relative to the granite table (print table 50), and a fixture plate 55 mounted on the stage moves by definition in the first direction (X-direction).

FIG. 2 is a schematic cross sectional view of an individual membrane holder 44 and part of the fixture plate 55. The membrane holder 44 carries one membrane 41 as a part of the substrate 40. One membrane 41 is also denoted a substrate area 41. Each individual membrane holder 44 is located on the fixture plate 55. On the substrate 40, i.e. on each membrane 41, a plurality of substrate locations 42 are provided such that individual droplets or dots of a droplet (schematically referenced 22 in FIG. 2) can be located at a distance from one another. It is thus possible to dispense or position a different kind of substance on each of the substrate locations 42. The membrane holder 44 is positioned in a hole 57 of the fixture plate 55 or registration plate 55. The print head 20 of the ink jet device 10 is preferably located on a first (“upper”) side 40′ of the substrate 40 and an acoustic sensor 60 is preferably located on a second (“lower”) side 40″ of the substrate 40, the second side 40″ being located opposite the first side 40′. The acoustic sensor 60 is preferably located in a further recess 61 located in the hole 57. The acoustic sensor 60 is shown schematically only in FIG. 2, i.e. for example without connecting lines or the like. It will be evident to those skilled that such connecting lines have to be present for conducting a signal from the acoustic sensor 60 to a processing and/or control device (not shown), where the data or the signals generated by the acoustic sensor 60 are processed. Preferably, the acoustic sensor 60 is constructed as a microphone.

FIG. 3 is a schematic plan view of a fixture plate 55 with a plurality of membrane areas 41, 41a, 41b and acoustic sensors 60, 60a, 60b. One acoustic sensor 60, 60a, 60b is associated with each membrane area 41, 41a, 41b. This means that e.g. the acoustic sensor 60a associated with the membrane area 41a detects the landing of a droplet 22 only, or at least to a very much higher degree, if the droplet 22 lands on the membrane area 41a. The same is the case for the acoustic sensor 60b associated with the membrane area 41b and for the acoustic sensor 60 associated with the membrane area 41. It is possible with this plurality of acoustic sensors 60, located in different positions on the substrate 40, to detect not only whether a droplet 22 has landed (somewhere) on the substrate 40 but also to detect the precise membrane area 41 on which the droplet 22 has landed.

FIG. 4 schematically illustrates an alternative embodiment of a fixture plate 55 of an inventive ink jet device 10. The membrane holders 44 are located in recesses 56 of this alternative embodiment of the fixture plate 55. The further recesses 61 for the acoustic sensors 60 are schematically shown in these recesses 56. The membrane areas 41 are located on the membrane holders 44.

FIG. 5a shows part of a membrane 41 or a substrate area 41 from the top. A plurality of substrate locations 42, 42a, 42b are defined on the substrate area 41. The substrate locations 42, 42a, 42b are the locations where the droplets 22 are to be positioned by the ink jet device 10 according to the present invention. Is it also possible to place a plurality of droplets in one single substrate location 42. The droplets 22 ejected by the print head 20 and landed on the substrate 40 will cover a certain droplet area or spot around the substrate locations 42, 42a, 42b with an average diameter 43 which is smaller than the mutual distance 43′ (or pitch) of the substrate locations 42, 42a, 42b.

FIG. 5b is a plan view of a substrate area 41 where a plurality of substrate locations 42 are represented by small circles. According to the present invention, many different substances can be deposited on these different substrate locations 42 in order to use the membrane of the substrate area 41 for diagnostic purposes. According to the present invention, it is possible to define several groups 42′ of substrate locations 42 in order to perform a complete set of tests within one group 42′ of substrate locations 42 and their respective substances.

FIG. 6 schematically and partly shows a further embodiment of the ink jet device 10 of the present invention. The print head holder 51′ moving along the Y axis with respect to the printing bridge 51 is provided with a further print head 20a and third print head 20b in addition to the print head 20. Accordingly, a further control camera 30a and third control camera 30b are positioned near the print heads 20, 20a, 20b. According to the present invention, the print heads 20, 20a, 20b are located such that droplets 22 ejected by different print heads 20, 20a, 20b are supposed to land on different membrane areas 41, 41a, 41b. This makes it possible to eject a plurality of droplets 22 from a plurality of print heads 20, 20a, 20b simultaneously or at least only very closely spaced in time, while it is still possible to distinguish the landing of each of the droplets 22 on the substrate 40 or on its respective membrane area 41, 41a, 41b.

In the embodiment according to FIG. 6, three or more single nozzle print heads 20, 20a, 20b (pipettes) mounted rigidly on the linear stage on the bridge 51 move by definition in the second direction (Y-direction). The print heads 20, 20a, 20b can be moved to any position on the substrate 40 by simultaneously moving the substrate 40 in the X?-direction and/or the printing bridge 51 together with the print heads 20, 20a, 20b in the Y-direction. The distance of the print heads 20, 20a, 20b is equal as much as possible to the pitch of the membrane areas 41 in the Y-direction. The fixture plate 55 is mounted rigidly on top of the print table 50. The fixture plate 55 is also called carrier 55 for the membrane areas 41 or for the membrane holders 44. The use of more than one print head 20 means that a shorter printing time can be obtained in that a number of single-nozzle print heads are used in parallel.

According to the invention, the print protocol is preferably processed in the following manner: Preferably, the membranes 41 are first aligned relative to the print table 50 or the fixture plate 55. This serves to en sure that the position information of the droplet 22 is known in three dimensions. The ejection of a droplet 22 from a print head 20, 20a, 20b is preferably detected by cameras, and the landing of the droplet 22 on the substrate 40 is detected in real-time by the acoustic sensor or sensors 60, 60a, 60b. All the signals and data from the sensors or cameras are recorded by software and stored in a memory.

On a substrate area 41, for example, 130 spots or substrate locations 42 can be provided where droplets 22 can be printed, each droplet needing a volume of, e.g., around 1 nl. The diameter 43 of the spots or the droplets 22 is, for example, 200 μm, and they are placed in a pattern with a pitch of, e.g., 400 μm. Of course, it is also possible to provide smaller spots necessitating a smaller pitch of, for example, only 300 μm, 200 μm, 100 μm or even 50 μm. The 130 spots are printed, for example, with one single print head 20 which is provided with different substances 23. On the fixture plate 55, for example, 140 membrane holders 44 are arranged which are processed in one printing batch by the ink jet device 10. The pitch 43′ of the droplet spots lies in a range of 10 to 500 μm according to the present invention. The diameter 43 of the spots of the droplets 22 is in a range of about 20% to 70% of the actual pitch 43′. The volume of the droplets 22 has to be adapted to the preferred size of the spot and to the material of the substrate 40 used (e.g. dependent on whether the substrate absorbs the applied substance strongly or weakly). Typically, the volume of the droplets 22 is about 0.001 nl to 10 nl.

1. Ink jet device (10) for the controlled positioning of droplets (22) of a substance (23) onto a substrate (40), the device (10) comprising at least a print head (20) comprising a nozzle (21) designed to eject a droplet (22), the ink jet device (10) further comprising at least one acoustic sensor (60) arranged such that the landing of the droplet (22) on the substrate (40) is detected by the acoustic sensor (60).

2. Ink jet device (10) according to claim 1, wherein the vibrations of the substrate (40) during the landing of the droplet (22) are detected.

3. Ink jet device (10) according to claim 1, wherein the print head (20) is provided on a first side (40′) of the substrate (40), and wherein the at least one acoustic sensor (60) is provided on a second side (40″) of the substrate (40) opposite to the first side (40′).

4. Ink jet device (10) according to claim 1, wherein the acoustic sensor (60) is a microphone.

5. Ink jet device (10) according to claim 1, wherein the ink jet device (10) comprises a plurality of acoustic sensors (60, 60a, 60b).

6. Ink jet device (10) according to claim 1, wherein the substrate (40) comprises a plurality of substrate areas (41), each substrate area (41) preferably being a separate membrane (41) retained by a membrane holder (44).

7. Ink jet device (10) according to claim 5, wherein at least one acoustic sensor (60, 60a, 60b) is associated with each substrate area (41, 41a, 41b).

8. Ink jet device (10) according to claim 6, wherein the sensor signal of the at least one acoustic sensor (60, 60a, 60b) associated with one of the plurality of substrate areas (41, 41a, 41b) in response to a droplet (22) landing on said one of the substrate areas (41, 41a, 41b) strongly differs from the respective sensor signal thereof in response to a droplet (22) landing on a different one of the substrate areas (41, 41a, 41b).

9. Ink jet device (10) according to claim 7, wherein the ink jet device (10) comprises a stationary print table (50) and a movable fixture plate (55), said fixture plate (55) comprising a recess (56) or a hole (57) for each membrane holder (44).

10. Ink jet device (10) according to claim 8, wherein the acoustic sensor (60, 60a, 60b) associated with a given substrate area (41, 41a, 41b) is provided in the respective recess (56) or hole (57).

11. Ink jet device (10) according to claim 1, wherein the ink jet device (10) further comprises a print table (50) and a printing bridge (51) rigidly attached to the table, a fixture plate 55 being mounted so as to be movable relative to the print table (50) in a first direction (X-direction), and the print head (20) being mounted on a movable print head holder (51′) mounted to the printing bridge (51) such that the print head (20) is movable relative to the printing bridge (51) in a second direction (Y-direction).

12. Ink jet device (10) according to claim 10, wherein the first direction (X-direction) and the second direction (Y-direction) are mutually perpendicular.

13. Ink jet device (10) according to claim 1, wherein the substrate (40) is a flat substrate, a structured substrate, or a porous membrane (41), preferably a nylon membrane, a nitrocellulose membrane, or a PVDF membrane.

14. Ink jet device (10) according to claim 1, wherein the substrate (40) comprises a plurality of substrate locations (42, 42a, 42b), the substrate locations (42, 42a, 42b) being separated from each other by at least the average diameter (43) of a dot (22) positioned in one of the substrate locations (42, 42a, 42b).

15. Ink jet device (10) according to claim 1, wherein a plurality of droplets (22) are superposed on one substrate location (42, 42a, 42b).

16. Ink jet device (10) according to claim 1, wherein the substance (23) is transparent or strongly translucent.

17. Method for the controlled positioning of droplets (22) of a substance (23) onto a substrate (40) using an ink jet device (10) comprising at least a print head (20) that comprises a nozzle (21) designed to eject a droplet (22), the ink jet device (10) further comprising at least one acoustic sensor arranged such that the landing of the droplet (22) on the substrate (40) is detected by the acoustic sensor.

18. Method according to claim 17, wherein a feedback loop stops the printing process if, after ejection of the droplet (22), the landing of the droplet (22) on the substrate (40) is not detected by the acoustic sensor (60, 60a, 60b) within a predetermined delay time.

19. Method according to claim 17, wherein the position of the print head (20) relative to the substrate (40) is calibrated in a first step, and wherein the substance (23) is positioned on the substrate (40) in a second step.

20. Method according to claim 17, wherein a plurality of different substances (23) are applied to the substrate (40) such that a first substance (23a) is positioned in a first substrate location (42a) and a second substance (23b) is positioned in a second substrate location (42b).

21. Use of an ink jet device (10) according to claim 1, wherein the substance (23) comprises a biochemical reactant and/or a nucleic acid and/or a polypeptide and/or a protein.
